(19) United States
(12) Patent Application Publication
(10) Pub. No.: US 2006/0275606 A1
(43) Pub. Date: Dec. 7, 2006

(54) White pigment for water-based ink and process for producing the same

(75) Inventor: Akira Mizutani, Nagano-ken (JP)

Correspondence Address: LADAS & PARRY, 26 WEST 61ST STREET, NEW YORK, NY, 10023, US

(73) Assignee: SEIKO EPSON CORPORATION

(21) Appl. No.: 11/394,365

(22) Filed: Mar. 30, 2006

(30) Foreign Application Priority Data
Mar. 30, 2005 (JP) 2005-100115
Mar. 30, 2005 (JP) 2005-100116
Mar. 30, 2006 (JP) 2006-92787

(51) Int. Cl. C09D 11/02; B05D 3/02; B05D 7/00; B32B 1/00; B32B 19/00

(52) U.S. Cl. 428/404; 106/31.65; 106/31.9; 106/436; 106/447; 106/409; 427/212; 427/372.2

(57) ABSTRACT

There is provided a white pigment for a water-based ink that has excellent reliability against clogging and stability of pigment against settling and, at the same time, has a high level of covering power. The white pigment for a water-based ink comprises particles each comprising: a core particle formed of a material having a lower specific gravity than titanium oxide; and a titanium oxide layer covering the surface of the core particle, the pigment having a particle diameter of 0.05 to 5 μm.

### BACKGROUND OF THE INVENTION

1. Field of Invention

This invention relates to a white pigment for a water-based ink using titanium oxide and a process for producing the same.

2. Background Art

Ink jet recording is a method in which ink droplets are flied and adhered to a material for printing. Inks for ink jet recording used in this recording method is those prepared by dissolving or dispersing a colorant (dye or pigment) in a solvent, and optionally contain various additives added thereto. Among inks for ink jet recording, white inks, when printed, for example, on a black face having a low level of brightness on which printing is to be made, can provide highly visible recorded matter and thus are also useful as marking on industrial products of plastics and the like. In white pigment inks for water-based ink for ink jet recording, inorganic pigments such as titanium oxide have hitherto been mainly adopted as the pigment.

These inorganic pigments cause sedimentation or coagulation due to a difference in specific gravity between the pigment particles and the solvent for ink that poses problems of clogging of an ink jet head and lack of ink storage stability. Further, when pigment particles having a small diameter are used for clogging prevention purposes, in some cases, the covering power of the ink is unsatisfactory.

In order to overcome these problems, various studies have been made. For example, Japanese Patent Laid-Open No. 145570/1994 proposes the addition of a polymeric dispersant for dispersion of a pigment and a resin emulsion to the ink, for providing an ink having less susceptibility to clogging and excellent storage stability. Further, an attempt to improve the dispersion stability of the pigment has been made by surface treating the pigment. For example, Japanese Patent Laid-Open No. 348513/2002 discloses a white pigment prepared by surface treating titanium oxide with an inorganic phosphoric acid compound.

The improvement in dispersibility of the pigment by using a dispersant is disadvantageous in that, when the concentration of the pigment is increased for providing inks having improved covering power, the addition of an excessive amount of the dispersant is necessary due to the increased pigment concentration, often leading to deteriorated print quality.

Further, surface-treated inorganic white pigments can be stably dispersed in ink when the particle diameter of the pigment is a certain value or less, but on the other hand, when a pigment having a larger particle diameter is used for enhancing the covering power, due to high specific gravity of the pigment, sedimentation of the pigment disadvantageously occurs.

### SUMMARY OF THE INVENTION

The present inventors have now found that a white pigment for a water-based ink having excellent reliability against clogging and stability of pigment against sedimentation and, at the same time, having a high level of covering power can be provided by covering the surface of a material having a smaller specific gravity than titanium oxide with titanium oxide.

The present inventors have further found that a white pigment for a water-based ink having excellent reliability against clogging and stability of pigment against sedimentation and, at the same time, having a high level of covering power can be provided by mixing titanium oxide particles and resin particles having a smaller specific gravity than titanium oxide together at a predetermined mixing ratio. The present invention has been made based on such finding.

Accordingly, an object of the present invention is to provide a white pigment for a water-based ink having excellent reliability against clogging and stability of pigment against sedimentation and, at the same time, having a high level of covering power.

According to the present invention, there is provided a white pigment for a water-based ink, comprising particles each comprising: a core particle formed of a material having a lower specific gravity than titanium oxide; and a titanium oxide layer covering the surface of the core particle, the pigment having a particle diameter of 0.05 to 5 μm.

According to another aspect of the present invention, there is provided a white pigment for a water-based ink, comprising titanium oxide particles and resin particles having a lower specific gravity than titanium oxide, wherein the mixing weight ratio between the titanium oxide particles and the resin particles is 5:1 to 1:30.

According to a further aspect of the present invention, there is provided a process for producing a white pigment for a water-based ink, comprising:

providing an aqueous emulsion containing the core particles;

adding the aqueous emulsion to an organic solvent containing a titanium alkoxide dissolved therein; and

precipitating titanium oxide on the surface of the core particles by hydrolysis of the titanium alkoxide.

The present invention can realize a white pigment for a water-based ink that has excellent reliability against clogging and stability of pigment against settling and, at the same time, has a high level of covering power.

### BRIEF DESCRIPTION OF THE DRAWINGS

FIG. 1 is a cross-sectional view showing an embodiment of the white pigment for water-based ink according to the present invention;

FIG. 2 is a cross-sectional view showing another embodiment of the white pigment for water-based ink according to the present invention;

FIG. 3 is an infrared spectroscopic spectrum of the pigment prepared in Example 1; and

FIG. 4 is an electron photomicrograph of the pigment prepared in Example 1.

### DETAILED DESCRIPTION OF THE INVENTION

<White Pigment for Water-based Ink>

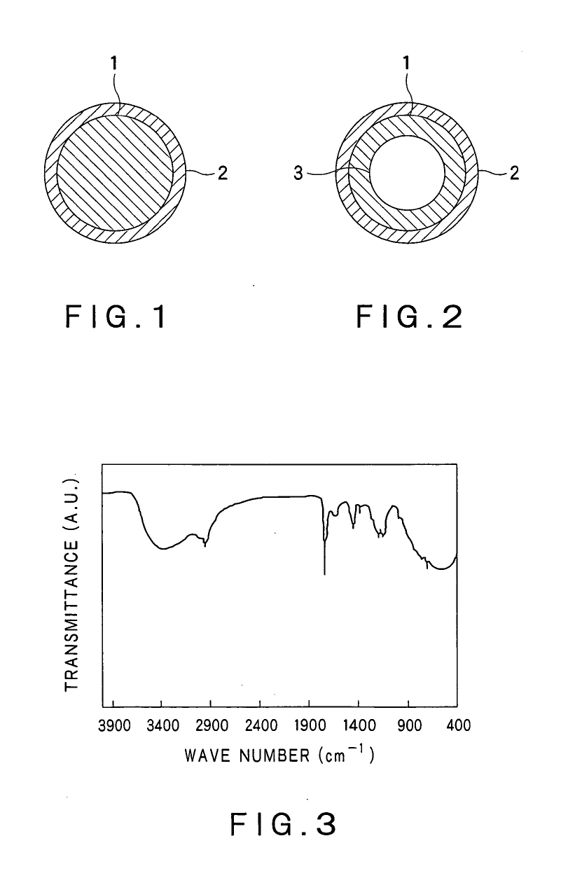

As shown in FIG. 1, the water-based white pigment according to the first aspect of the present invention has such a structure that the surface of core particles having a smaller specific gravity than titanium oxide is covered with a titanium oxide layer. In this case, the pigment has a particle diameter of 0.05 to 5 μm.

In the prior art technique, the use of a white pigment of titanium oxide having a particle diameter of about 0.05 to 5 μm for enhancing the covering power of the white pigment caused such a phenomenon that the pigment settled and coagulated in the ink. In the present invention, as compared with a pigment formed of titanium oxide alone, the specific gravity of a white pigment can be rendered smaller by adopting a white pigment structure in which the surface of a core formed of a material having a smaller specific gravity than titanium oxide is covered with a titanium oxide layer. According to this construction, even when pigment particles having relatively large particles having a diameter of about 0.05 to 5 μm, which has high covering power, are used, the pigment can stably exist in the ink, because the specific gravity of the pigment is smaller than that of the white pigment of titanium oxide alone. Further, since light is refracted in the interface of the core and the titanium oxide layer, the covering power is higher than the white pigment of titanium oxide alone, although this depends upon the material constituting the core.

The particle diameter of the white pigment for water-based ink according to the present invention is preferably such that the particle diameter d₅₀ in a cumulative mass fraction of 50% is 0.05 to 5 μm, more preferably such that the d₅₀ value is 0.05 to 3 μm.

The covered titanium oxide is preferably in a noncrystalline form, an anatase crystal form, or a rutile crystal form, more preferably an anatase crystal form. When the surface of the core particles is covered with titanium oxide in an anatase crystal form, a white ink having further improved covering power can be provided.

In a preferred embodiment of the present invention, as shown in FIG. 2, the core particles have a hollow structure. When the core particles have voids, the apparent specific gravity of the white pigment is reduced. Therefore, even when the pigment has a large particle diameter of about 0.05 to 5 μm, the sedimentation of the pigment is suppressed and, at the same time, the dispersion stability is excellent. Since light is refracted at the interface between the core and the voids and the interface between the core and the titanium oxide layer, a white pigment having a higher level of covering power can be provided.

The material for the core particles is not particularly limited, and general-purpose water soluble resins can be properly used. In the present invention, however, the resin used should have a smaller specific gravity than titanium oxide. The specific gravity of titanium oxide is about 4.0 although it depends upon the crystal structure and the like. In the present invention, a resin having a smaller specific gravity than this value should be used. Among water soluble resins, resins having a polar group is preferred. Suitable resins include, for example, acryl resins, acrylamide resins, styrene-acryl resin, urethane resins, epoxy resins, polyimide resins, polyamide resins, polyvinyl alcohol resins, cellulose resins, and polyester resins. Among them, thermoplastic polyester resins are preferred.

Methods usable for forming hollow core particles as shown in FIG. 2 include, for example, a method in which a thermoplastic polyester resin is heat treated in an aqueous medium having low ionic strength at a temperature at or above the glass transition temperature, a method in which, after the addition of a water soluble organic compound to an aqueous dispersion of ionic group-containing polyester resin particles, the water soluble organic compound is removed by azeotropy to form a hollow structure in the core particles, and a method in which a solvent is added to an aqueous dispersion of ionic group-containing polyester resin particles to swell the core particles and the swollen core particles are then dried by spray drying or other method to form a hollow structure in the particles.

Among the above methods, the method in which heat treatment is carried out in an aqueous medium having low ionic strength at a temperature at or above the glass transition temperature, is preferred. According to this method, desired core particles can easily be prepared by properly selecting the heat treatment temperature and the ion strength (electrolyte concentration) in the system. From the viewpoints of the glass transition temperature of the polyester resin, the treatment temperature is preferably 200° C. or below, 140° C. or below, more preferably 100° C., particularly preferably 90° C. or below. In the case of monovalent ions, the electrolyte concentration is preferably not more than 0.2 mol/liter, more preferably not more than 0.1 mol/liter, particularly preferably not more than 0.05 mol/liter.

The core particles having a hollow structure may be commercially available products, and suitable commercially available products include, for example, “ROPAQUE OP-84J,” “ROPAQUE OP-62,” and “ROPAQUE HP-91” manufactured by Rohm & Haas; “SX863A” and “SX866B” manufactured by JSR Corporation; “Voncoat,” “Grandoll PP-1000,” “Grandoll PP-1001,” and “Grandoll PP-2000” manufactured by Dainippon Ink and Chemicals, Inc.; and “Latex SBL 8801” manufactured by Asahi Kasei Kogyo K. K.

Preferably, the core particles having the above hollow structure have a particle diameter of 0.01 to 3 μm. When the particle diameter is in the range of 0.01 to 3 μm, reliability against clogging and stability of the pigment against sedimentation can be further enhanced and, at the same time, the covering power of the white pigment can be further enhanced.

The white pigment for water-based ink according to the second aspect of the present invention comprises titanium oxide particles and resin particles having a lower specific gravity than titanium oxide, wherein the mixing weight ratio between the titanium oxide particles and the resin particles is 5:1 to 1:30. A white pigment, which has excellent reliability against clogging and stability of pigment against settling and, at the same time, has a high level of covering power, can be prepared by mixing the titanium oxide particles and the resin particles together at the above-defined mixing ratio. The reason for this has not been elucidated yet, but is believed to reside in that, when a mixture of titanium oxide particles with resin particles is dispersed as a pigment in ink, a white pigment, which is excellent in both stability and covering power, is obtained by virtue of mutual interaction between the titanium oxide particles and the resin particles. The mixing ratio of the titanium oxide particles to the resin particles is preferably 3:1 to 1:20.

Resin particles having a hollow structure are suitable as the resin particles. Specifically, the resin particles may be the same as the resin particles having a hollow structure used in the above core particles.

Titanium oxide (TiO₂) used commonly in pigments may be mentioned as titanium oxide. TiO₂ may be classified, for example, into rutile type, anatase type, and brookite type according to the difference in crystal structure. In the present invention, TiO₂ belonging to any of the above categories may be used. Preferred are rutile type and anatase type.

The diameter of titanium oxide particles is preferably 0.05 to 5 μm. When the diameter is in the above-defined range, the stability of the white pigment in the ink is further improved.

The amount of titanium oxide added in the ink composition according to the present invention is preferably about 5 to 50% by weight, more preferably about 5 to 30% by weight.

Titanium oxide may be the same as titanium oxide used in the white pigment in the first embodiment.

<Production Process of White Pigment for Water-based>Ink According to First Aspect of Present Invention

The production process according to the present invention comprises the steps of: providing an aqueous emulsion containing core particles; adding the aqueous emulsion to an organic solvent containing a titanium alkoxide dissolved therein; and precipitating titanium oxide on the surface of the core particles by hydrolysis of the titanium alkoxide. Thus, a white pigment for water-based ink, comprising core particles and a layer formed of titanium oxide covering the surface of the core particles can be provided.

In the present invention, titanium alkoxides, specifically titanium alkoxides having three or more carbons such as titanium tetraisopropoxide, titanium tetra-n-butoxide, or titanium tetraisobutoxide, are used as a starting material for titanium oxide in the present invention. In the present invention, since the titanium alkoxide is used as the starting material, an alcohol corresponding to the alkoxide is produced as a reaction by-product. Unlike the case where titanium(IV) chloride is used as the starting material, hydrogen chloride which is toxic does not occur as the reaction by-product. Thus, the production process is advantageous in that the reaction can easily be carried out.

A titanium alkoxide as a starting material is first dissolved in an aprotic solvent. The aprotic solvent may be one solvent or a mixture of two solvents selected from aromatic hydrocarbon solvents, aliphatic hydrocarbon solvents, ether solvents, ketone solvents, and ester solvents.

Monocyclic hydrocarbon solvents such as toluene, xylene, and anisole may be used as the aromatic hydrocarbon solvent. Aliphatic hydrocarbon solvents include straight chain aliphatic hydrocarbon solvents such as pentane, hexane, heptane, octane, and decane, alicyclic hydrocarbon solvents such as tetralin, and mixed solvents composed of various hydrocarbons such as petroleum ether and ligroin. Ether solvents include straight chain ethers such as diethyl ether and cyclic ethers such as tetrahydrofuran. Ketone solvents include methyl ethyl ketone and methyl isobutyl ketone. Ester solvents include ethyl acetate and butyl acetate.

The aprotic solvent containing the titanium alkoxide dissolved therein is cooled to −20° C. or below. The lower the cooling temperature, the better the results. The temperature at which the solution coagulates varies depending upon the type of the solvent used. Cooling to a temperature at which the solution does not coagulate is preferred.

Subsequently, a core particle-containing aqueous emulsion is added dropwise to the titanium alkoxide solution cooled to −20° C. or below, and the mixture is vigorously stirred, whereby a hydrolysis reaction of the titanium alkoxide takes place to produce titanium oxide. The concentration of the core particles in the aqueous emulsion is preferably 1 to 80% by weight.

When the aqueous emulsion is added dropwise to an aprotic solution of −20° C. or below, the aqueous emulsion coagulates. Accordingly, the aprotic solution of a titanium alkoxide should be thoroughly stirred. The reaction vessel containing the aprotic solution of the titanium alkoxide may be vibrated with stirring.

Thus, a part of the titanium oxide is precipitated on the surface of the core particles, and, as a reaction proceeds, a layer of titanium oxide is formed. A part of the produced titanium oxide is also precipitated in the solution rather than the surface of the core particles and is settled at the bottom of the reaction vessel.

The layer of titanium oxide can be formed on the surface of the core particles to a desired thickness by properly selecting, for example, the alkali concentration, reaction time, and reaction temperature in the alkali treatment of the aqueous emulsion, and the solid content of the aqueous emulsion, the solid content of the titanium alkoxide solution, reaction time, reaction temperature and the like in the reaction of the titanium alkoxide with the aqueous emulsion.

Preferably, this reaction solution is heat treated in a hermetically sealed vessel. Upon this heat treatment, a titanium oxide layer having an anatase crystal form is formed. The heat treatment temperature is preferably 100° C. or above. The heat treatment time is about 24 hr. That the titanium oxide layer has an anatase crystal form, can be confirmed by measuring a Raman spectrum of the resultant white pigment. Specifically, when titanium oxide has an anatase crystal form, peaks characteristic of the anatase crystal structure are observed around 145 cm⁻¹, 396 cm⁻¹, 517 cm⁻¹, and 637 cm⁻¹.

After the reaction, upon centrifugation, the reaction liquid is separated into a solid layer of titanium oxide as a by-product, an aqueous emulsion layer containing core particles having a surface coated with a layer of titanium oxide, and an aprotic solvent layer. The centrifugation is preferably carried out immediately after the reaction under conditions of rotating speed of 1000 to 15000 rpm and centrifugation time 30 to 90 min.

A white pigment for water-based ink, having a structure comprising core particles having a surface covered with a layer of titanium oxide, is obtained by the separation of the individual layer after the centrifugation. The separated aprotic solvent layer is removed, and the solid layer of titanium oxide can be separated from the aqueous emulsion layer containing contemplated core particles by separating operation such as decantation.

In the white pigment for water-based ink, the surface of the layer of titanium oxide may be hydrophilized to improve the solubility or dispersibility of the white pigment in ink.

<Process for Producing White Pigment for Water-based Ink According to Second Aspect of Present Invention>

Titanium oxide (TiO₂) used commonly in pigments may be mentioned as titanium oxide used in the white pigment for water-based ink according to the second aspect of the present invention. TiO₂ may be classified, for example, into rutile type, anatase type, and brookite type according to the difference in crystal structure. In the present invention, TiO₂ belonging to any of the above categories may be used. Preferred are rutile type and anatase type.

In the process for producing the white pigment for water-based ink according to the second aspect of the present invention, preferably, titanium oxide is added, as a titanium oxide dispersion liquid prepared by dispersing titanium oxide in an aqueous medium with the aid of a dispersant or a surfactant, to the ink composition.

Dispersants commonly used in the preparation of pigment dispersion liquids, for example, polymeric dispersants, may be mentioned as the dispersant usable in the ink composition according to the present invention. Various anionic surfactants, nonionic surfactants, cationic surfactants, and amphoteric-surfactants which will be described later, may be mentioned as the surfactant used as the dispersant.

The pigment according to the present invention may be prepared according to any conventional formulation without particular limitation. For example, titanium oxide, a polymeric dispersant, and pure water are mixed together in a suitable dispergator, for example, a ball mill, a sand mill, an attritor, a roll mill, an agitator mill, a Henschel mixer, a colloid mill, an ultrasonic homogenizer, a jet mill, and an angmill, to prepare a homogeneous pigment dispersion liquid. Further, resin particles having a smaller specific gravity than titanium oxide (for example, resin particles having a hollow structure), a water soluble organic solvent, a wetting agent, a surfactant, and a pH adjuster are added, and the mixture is thoroughly stirred at room temperature to prepare an ink solvent. The above pigment dispersion liquid is gradually added to the ink solvent stirred in a suitable dispergator, and the mixture is thoroughly stirred. After stirring, the mixture is filtered to remove coarse particles and foreign material to prepare a contemplated ink composition. In the preparation of the ink, conventional dispersion methods, defoaming methods, and filtration methods are usable.

<Ink Composition>

The ink composition according to the present invention comprises the above white pigment for water-based ink as a colorant. The ink composition may further comprise, in addition to the colorant, water, water soluble organic solvents, wetting agents, polymeric dispersants, surfactants, and other various additives.

The amount of the white pigment for water-based ink according to the present invention added is preferably about 1 to 40% by mass, more preferably 3 to 30% by mass, based on the total amount of the ink. In the present invention, even in the case of such a high pigment concentration, high pigment dispersibility and high reliability of the pigment particles against clogging can be realized. At the same time, images having a high level of covering power can be produced by increasing the concentration of the pigment in the ink.

The solvent in the ink composition according to the present invention preferably comprises water and a water soluble organic solvent. Water may be pure water obtained by ion exchange, ultrafiltration, reverse osmosis, distillation or the like, or ultrapure water. Water, which has been sterilized, for example, by ultraviolet irradiation or by addition of hydrogen peroxide, is suitable, because this treatment can prevent the growth of mold or bacteria and, thus, the ink composition can be stored for a long period of time. The water soluble organic solvent is preferably a low-boiling organic solvent, and examples thereof include methanol, ethanol, n-propyl alcohol, iso-propyl alcohol, n-butanol, sec-butanol, tert-butanol, iso-butanol, and n-pentanol. Monohydric alcohols are particularly preferred. The low-boiling organic solvent has the effect of shortening the time necessary for drying the ink. The amount of the low-boiling organic solvent added is preferably 0.5 to 10% by mass, more preferably 1.5 to ⁶% by mass, based on the ink.

The ink composition according to the present invention preferably further comprises a wetting agent such as a high-boiling organic solvent. Examples of preferred wetting agents include: polyhydric alcohols, such as ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, and trimethylolpropane; alkyl ethers of polyhydric alcohols, for example, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether; urea; 2-pyrrolidone; N-methyl-2-pyrrolidone; and 1,3-dimethyl-2-imidazolidinone.

The amount of the wetting agent added is preferably 0.5 to 40% by mass, more preferably 2 to 20% by mass, based on the ink.

The ink composition according to the present invention preferably contains a polymeric dispersant. Polymeric dispersants include naturally occurring polymers. Specific examples of naturally occurring polymers include proteins such as glue, gelatin, casein, and albumin; naturally occurring rubbers such as gum arabic and tragacanth; glucosides such as sabonin; alginic acid and alginic acid derivatives such as propylene glycol alginate, triethanolamine alginate, and ammonium alginate; and cellulose derivatives such as methylcellulose, carboxymethylcellulose, hydroxyethylcellulose, and ethylhydroxycellulose. Further examples of preferred polymeric dispersants include synthetic polymers, and examples thereof include: polyvinyl alcohols; polyvinyl pyrrolidones; acrylic resins such as polyacrylic acid, acrylic acid/acrylonitrile copolymer, potassium acrylate/acrylonitrile copolymer, vinyl acetate/acrylic ester copolymer, and acrylic acid/acrylic ester copolymer; styrene/acrylic acid resins such as styrene/acrylic acid copolymer, styrene/methacrylic acid copolymer, styrene/methacrylic acid/acrylic ester copolymer, styrene/α-methylstyrene/acrylic acid copolymer, and styrene/α-methylstyrene/acrylic acid/acrylic ester copolymer; styrene/maleic acid copolymer; styrene/maleic anhydride copolymer; vinylnaphthalene/acrylic acid copolymer; vinylnaphthalene/maleic acid copolymer; vinyl acetate copolymers such as vinyl acetate/ethylene copolymer, vinyl acetate/crotonic acid copolymer, and vinyl acetate/acrylic acid copolymer; and salts of the above polymers. Among them, a copolymer of a monomer having a hydrophobic group with a monomer having a hydrophilic group and a polymer of a monomer having both a hydrophobic group and a hydrophilic group, in its molecular structure for example, styrene/acrylic acid copolymer and styrene/methacrylic acid copolymer, are particularly preferred.

The ink composition according to the present invention may further comprises a surfactant. Surfactants include anionic surfactants (for example, sodium dodecylbenzenesulfonate, sodium laurylate, and ammonium salts of polyoxyethylene alkyl ether sulfates), nonionic surfactants (for example, polyoxyethylene alkyl ethers, polyoxyethylene alkyl esters, polyoxyethylene sorbitan fatty acid esters, polyoxyethylene alkylphenyl ethers, polyoxyethylenealkylamines, and polyoxyethylenealkylamides), and acetylene glycols (OLFINE Y, Surfynol 82, Surfynol 104, Surfynol 440, Surfynol 465, and Surfynol 485 (all the above products being manufactured by Air Products and Chemicals Inc.), and phosphoric ester surfactants (Phosphanol RS-410, Phosphanol RS-610, and Phosphanol RS-710 (manufactured by Toho Chemical Industry Co., Ltd.)). They may be used either solely or in a combination of two or more. If necessary, pH adjustors, preservatives, fungicides, antioxidants and other additives may also be added.

Further, in the present invention, a light color ink can be prepared by adding a suitable amount of a pigment and/or a dye other than the white pigment for water-based ink according to the present invention. Various dyes or pigments are usable, and alkali soluble dyes and pigments are particularly preferred.

Specific examples of such dyes include direct dyes, for example, C.I. Direct Black 2, C.I. Direct Black 4, C.I. Direct Black 9, C.I. Direct Black 11, C.I. Direct Black 14, C.I. Direct Black 17, C.I. Direct Black 19, C.I. Direct Black 22, C.I. Direct Black 27, C.I. Direct Black 32, C.I. Direct Black 36, C.I. Direct Black 38, C.I. Direct Black 41, C.I. Direct Black 48, C.I. Direct Black 49, C.I. Direct Black 51, C.I. Direct Black 56, C.I. Direct Black 62, C.I. Direct Black 71, C.I. Direct Black 74, C.I. Direct Black 75, C.I. Direct Black 77, C.I. Direct Black 78, C.I. Direct Black 80, C.I. Direct Black 91, C.I. Direct Black 105, C.I. Direct Black 106, C.I. Direct Black 107, C.I. Direct Black 108, C.I. Direct Black 112, C.I. Direct Black 113, C.I. Direct Black 117, C.I. Direct Black 122, C.I. Direct Black 132, C.I. Direct Black 146, C.I. Direct Black 151, C.I. Direct Black 154, and C.I. Direct Black 194; C.I. Direct Blue 1, C.I. Direct Blue 2, C.I. Direct Blue 6, C.I. Direct Blue 8, C.I. Direct Blue 10, C.I. Direct Blue 14, C.I. Direct Blue 15, C.I. Direct Blue 22, C.I. Direct Blue 25, C.I. Direct Blue 34, C.I. Direct Blue 69, C.I. Direct Blue 70, C.I. Direct Blue 71, C.I. Direct Blue 72, C.I. Direct Blue 75, C.I. Direct Blue 76, C.I. Direct Blue 78, C.I. Direct Blue 80, C.I. Direct Blue 81, C.I. Direct Blue 82, C.I. Direct Blue 83, C.I. Direct Blue 86, C.I. Direct Blue 90, C.I. Direct Blue 95, C.I. Direct Blue 98, C.I. Direct Blue 106, C.I. Direct Blue 108, C.I. Direct Blue 110, C.I. Direct Blue 120, C.I. Direct Blue 123, C.I. Direct Blue 158, C.I. Direct Blue 159, C.I. Direct Blue 163, C.I. Direct Blue 165, C.I. Direct Blue 192, C.I. Direct Blue 193, C.I. Direct Blue 194, C.I. Direct Blue 195, C.I. Direct Blue 196, C.I. Direct Blue 199, C.I. Direct Blue 200, C.I. Direct Blue 201, C.I. Direct Blue 202, C.I. Direct Blue 203, C.I. Direct Blue 207, C.I. Direct Blue 218, C.I. Direct Blue 236, C.I. Direct Blue 237, C.I. Direct Blue 239, C.I. Direct Blue 246, and C.I. Direct Blue 258; C.I. Direct Brown 1A, C.I. Direct Brown 2, C.I. Direct Brown 6, C.I. Direct Brown 25, C.I. Direct Brown 27, C.I. Direct Brown 31, C.I. Direct Brown 44, C.I. Direct Brown 52, C.I. Direct Brown 58, C.I. Direct Brown 95, C.I. Direct Brown 100, C.I. Direct Brown 101, C.I. Direct Brown 106, C.I. Direct Brown 112, C.I. Direct Brown 173, C.I. Direct Brown 194, C.I. Direct Brown 195, C.I. Direct Brown 209, C.I. Direct Brown 210, C.I. Direct Brown 211, and C.I. Direct Brown 222; C.I. Direct Green 1, C.I. Direct Green 6, C.I. Direct Green 8, C.I. Direct Green 26, C.I. Direct Green 28, C.I. Direct Green 33, C.I. Direct Green 37, C.I. Direct Green 59, C.I. Direct Green 63, and C.I. Direct Green 64; C.I. Direct Orange 6, C.I. Direct Orange 8, C.I. Direct Orange 10, C.I. Direct Orange 26, C.I. Direct Orange 29, C.I. Direct Orange 32, C.I. Direct Orange 39, C.I. Direct Orange 40, C.I. Direct Orange 41, C.I. Direct Orange 46, C.I. Direct Orange 49, C.I. Direct Orange 51, and C.I. Direct Orange 102; C.I. Direct Red 1, C.I. Direct Red 2, C.I. Direct Red 4, C.I. Direct Red 8, C.I. Direct Red 9, C.I. Direct Red 11, C.I. Direct Red 13, C.I. Direct Red 17, C.I. Direct Red 20, C.I. Direct Red 23, C.I. Direct Red 24, C.I. Direct Red 26, C.I. Direct Red 28, C.I. Direct Red 31, C.I. Direct Red 33, C.I. Direct Red 37, C.I. Direct Red 39, C.I. Direct Red 44, C.I. Direct Red 46, C.I. Direct Red 47, C.I. Direct Red 48, C.I. Direct Red 51, C.I. Direct Red 54, C.I. Direct Red 59, C.I. Direct Red 62, C.I. Direct Red 72, C.I. Direct Red 75, C.I. Direct Red 76, C.I. Direct Red 79, C.I. Direct Red 80, C.I. Direct Red 81, C.I. Direct Red 83, C.I. Direct Red 90, C.I. Direct Red 99, C.I. Direct Red 101, C.I. Direct Red 111, C.I. Direct Red 113, C.I. Direct Red 145, C.I. Direct Red 189, C.I. Direct Red 220, C.I. Direct Red 225, C.I. Direct Red 230, and C.I. Direct Red 234; C.I. Direct Violet 1, C.I. Direct Violet 7, C.I. Direct Violet 9, C.I. Direct Violet 12, C.I. Direct Violet 35, C.I. Direct Violet 47, C.I. Direct Violet 48, C.I. Direct Violet 51, C.I. Direct Violet 66, C.I. Direct Violet 90, and C.I. Direct Violet 94; and C.I. Direct Yellow 1, C.I. Direct Yellow 2, C.I. Direct Yellow 4, C.I. Direct Yellow 8, C.I. Direct Yellow 11, C.I. Direct Yellow 12, C.I. Direct Yellow 22, C.I. Direct Yellow 24, C.I. Direct Yellow 26, C.I. Direct Yellow 27, C.I. Direct Yellow 28, C.I. Direct Yellow 29, C.I. Direct Yellow 33, C.I. Direct Yellow 34, C.I. Direct Yellow 39, C.I. Direct Yellow 41, C.I. Direct Yellow 42, C.I. Direct Yellow 44, C.I. Direct Yellow 48, C.I. Direct Yellow 50, C.I. Direct Yellow 51, C.I. Direct Yellow 58, C.I. Direct Yellow 72, C.I. Direct Yellow 85, C.I. Direct Yellow 86, C.I. Direct Yellow 87, C.I. Direct Yellow 88, C.I. Direct Yellow 98, C.I. Direct Yellow 100, C.I. Direct Yellow 106, C.I. Direct Yellow 110, C.I. Direct Yellow 132, C.I. Direct Yellow 142, and C.I. Direct Yellow 144.

Examples of acid dyes include C.I. Acid Black 1, C.I. Acid Black 2, C.I. Acid Black 7, C.I. Acid Black 16, C.I. Acid Black 17, C.I. Acid Black 21, C.I. Acid Black 24, C.I. Acid Black 26, C.I. Acid Black 28, C.I. Acid Black 31, C.I. Acid Black 41, C.I. Acid Black 48, C.I. Acid Black 52, C.I. Acid Black 56, C.I. Acid Black 58, C.I. Acid Black 60, C.I. Acid Black 63, C.I. Acid Black 84, C.I. Acid Black 94, C.I. Acid Black 107, C.I. Acid Black 109, C.I. Acid Black 112, C.I. Acid Black 118, C.I. Acid Black 119, C.I. Acid Black 121, C.I. Acid Black 122, C.I. Acid Black 123, C.I. Acid Black 131, C.I. Acid Black 155, C.I. Acid Black 156, C.I. Acid Black 172, C.I. Acid Black 194, and C.I. Acid Black 208; C.I. Acid Blue 1, C.I. Acid Blue 7, C.I. Acid Blue 9, C.I. Acid Blue 15, C.I. Acid Blue 22, C.I. Acid Blue 23, C.I. Acid Blue 25, C.I. Acid Blue 27, C.I. Acid Blue 29, C.I. Acid Blue 40, C.I. Acid Blue 41, C.I. Acid Blue 43, C.I. Acid Blue 45, C.I. Acid Blue 47, C.I. Acid Blue 49, C.I. Acid Blue 51, C.I. Acid Blue 53, C.I. Acid Blue 55, C.I. Acid Blue 56, C.I. Acid Blue 59, C.I. Acid Blue 62, C.I. Acid Blue 69, C.I. Acid Blue 74, C.I. Acid Blue 77, C.I. Acid Blue 78, C.I. Acid Blue 83, C.I. Acid Blue 90, C.I. Acid Blue 91, C.I. Acid Blue 92, C.I. Acid Blue 93, C.I. Acid Blue 102, C.I. Acid Blue 104, C.I. Acid Blue 111, C.I. Acid Blue 113, C.I. Acid Blue 117, C.I. Acid Blue 120, C.I. Acid Blue 124, C.I. Acid Blue 126, C.I. Acid Blue 145, C.I. Acid Blue 158, C.I. Acid Blue 161, C.I. Acid Blue 167, C.I. Acid Blue 171, C.I. Acid Blue 175, C.I. Acid Blue 183, C.I. Acid Blue 185, C.I. Acid Blue 193, C.I. Acid Blue 229, C.I. Acid Blue 234, C.I. Acid Blue 236, and C.I. Acid Blue 254; C.I. Acid Brown 4, C.I. Acid Brown 6, C.I. Acid Brown 8, C.I. Acid Brown 14, C.I. Acid Brown 17, C.I. Acid Brown 20, C.I. Acid Brown 102, and C.I. Acid Brown 105; C.I. Acid Green 3, C.I. Acid Green 5, C.I. Acid Green 9, C.I. Acid Green 12, C.I. Acid Green 16, C.I. Acid Green 19, C.I. Acid Green 20, C.I. Acid Green 25, C.I. Acid Green 27, C.I. Acid Green 35, C.I. Acid Green 41, and C.I. Acid Green 95; C.I. Acid Orange 1, C.I. Acid Orange 2, C.I. Acid Orange 7, C.I. Acid Orange 8, C.I. Acid Orange 10, C.I. Acid Orange 14, C.I. Acid Orange 19, C.I. Acid Orange 20, C.I. Acid Orange 24, C.I. Acid Orange 28, C.I. Acid Orange 33, C.I. Acid Orange 51, C.I. Acid Orange 52, C.I. Acid Orange 56, C.I. Acid Orange 61, C.I. Acid Orange 63, C.I. Acid Orange 64, C.I. Acid Orange 67, C.I. Acid Orange 74, C.I. Acid Orange 92, C.I. Acid Orange 125, C.I. Acid Orange 127, and C.I. Acid Orange 156; C.I. Acid Red 1, C.I. Acid Red 2, C.I. Acid Red 4, C.I. Acid Red 6, C.I. Acid Red 8, C.I. Acid Red 13, C.I. Acid Red 14, C.I. Acid Red 15, C.I. Acid Red 18, C.I. Acid Red 19, C.I. Acid Red 21, C.I. Acid Red 26, C.I. Acid Red 27, C.I. Acid Red 30, C.I. Acid Red 32, C.I. Acid Red 33, C.I. Acid Red 34, C.I. Acid Red 35, C.I. Acid Red 37, C.I. Acid Red 38, C.I. Acid Red 40, C.I. Acid Red 42, C.I. Acid Red 45, C.I. Acid Red 51, C.I. Acid Red 52, C.I. Acid Red 54, C.I. Acid Red 57, C.I. Acid Red 73, C.I. Acid Red 80, C.I. Acid Red 82, C.I. Acid Red 83, C.I. Acid Red 85, C.I. Acid Red 87, C.I. Acid Red 88, C.I. Acid Red 89, C.I. Acid Red 92, C.I. Acid Red 94, C.I. Acid Red 97, C.I. Acid Red 99, C.I. Acid Red 101, C.I. Acid Red 106, C.I. Acid Red 108, C.I. Acid Red 110, C.I. Acid Red 111, C.I. Acid Red 114, C.I. Acid Red 119, C.I. Acid Red 128, C.I. Acid Red 129, C.I. Acid Red 131, C.I. Acid Red 134, C.I. Acid Red 135, C.I. Acid Red 138, C.I. Acid Red 145, C.I. Acid Red. 151, C.I. Acid Red 154, C.I. Acid Red 155, C.I. Acid Red 161, C.I. Acid Red 172, C.I. Acid Red 176, C.I. Acid Red 179, C.I. Acid Red 180, C.I. Acid Red 183, C.I. Acid Red 184, C.I. Acid Red 186, C.I. Acid Red 187, C.I. Acid Red 214, C.I. Acid Red 243, C.I. Acid Red 248, C.I. Acid Red 249, C.I. Acid Red 254, C.I. Acid Red 256, C.I. Acid Red 257, C.I. Acid Red 266, C.I. Acid Red 270, C.I. Acid Red 288, C.I. Acid Red 289, C.I. Acid Red 296, C.I. Acid Red 317, C.I. Acid Red 318, C.I. Acid Red 337, and C.I. Acid Red 351; C.I. Acid Violet 1, C.I. Acid Violet 7, C.I. Acid Violet 9, C.I. Acid Violet 11, C.I. Acid Violet 15, C.I. Acid Violet 17, C.I. Acid Violet 34, C.I. Acid Violet 35, C.I. Acid Violet 41, C.I. Acid Violet 43, C.I. Acid Violet 49, C.I. Acid Violet 56, C.I. Acid Violet 58, and C.I. Acid Violet 75; and C.I. Acid Yellow 1, C.I. Acid Yellow 3, C.I. Acid Yellow 4, C.I. Acid Yellow 7, C.I. Acid Yellow 9, C.I. Acid Yellow 11, C.I. Acid Yellow 12, C.I. Acid Yellow 13, C.I. Acid Yellow 14, C.I. Acid Yellow 17, C.I. Acid Yellow 18, C.I. Acid Yellow 19, C.I. Acid Yellow 23, C.I. Acid Yellow 25, C.I. Acid Yellow 29, C.I. Acid Yellow 34, C.I. Acid Yellow 36, C.I. Acid Yellow 38, C.I. Acid Yellow 40, C.I. Acid Yellow 41, C.I. Acid Yellow 42, C.I. Acid Yellow 44, C.I. Acid Yellow 49, C.I. Acid Yellow 53, C.I. Acid Yellow 55, C.I. Acid Yellow 56, C.I. Acid Yellow 59, C.I. Acid Yellow 61, C.I. Acid Yellow 62, C.I. Acid Yellow 65, C.I. Acid Yellow 71, C.I. Acid Yellow 72, C.I. Acid Yellow 73, C.I. Acid Yellow 76, C.I. Acid Yellow 78, C.I. Acid Yellow 99, C.I. Acid Yellow 111, C.I. Acid Yellow 114, C.I. Acid Yellow 116, C.I. Acid Yellow 118, C.I. Acid Yellow 121, C.I. Acid Yellow 122, C.I. Acid Yellow 129, C.I. Acid Yellow 135, C.I. Acid Yellow 161, C.I. Acid Yellow 162, C.I. Acid Yellow 171, C.I. Acid Yellow 172, C.I. Acid Yellow 183, C.I. Acid Yellow 199, and C.I. Acid Yellow 201.

Basic dyes include, for example, C.I. Basic Black 2 and C.I. Basic Black 8; C.I. Basic Blue 1, C.I. Basic Blue 3, C.I. Basic Blue 5, C.I. Basic Blue 7, C.I. Basic Blue 9, C.I. Basic Blue 24, C.I. Basic Blue 25, C.I. Basic Blue 26, C.I. Basic Blue 28, and C.I. Basic Blue 29; C.I. Basic Brown 1 and C.I. Basic Brown 12; C.I. Basic Green 1 and C.I. Basic Green 4; C.I. Basic Orange 2, C.I. Basic Orange 15, C.I. Basic Orange 21, and C.I. Basic Orange 22; C.I. Basic Red 1, C.I. Basic Red 2, C.I. Basic Red 9, C.I. Basic Red 12, C.I. Basic Red 13, and C.I. Basic Red 37; C.I. Basic Violet 1, C.I. Basic Violet 3, C.I. Basic Violet 5, C.I. Basic Violet 7, C.I. Basic Violet 9, C.I. Basic Violet 24, C.I. Basic Violet 25, C.I. Basic Violet 26, C.I. Basic Violet 28, and C.I. Basic Violet 29; and C.I. Basic Yellow 1, C.I. Basic Yellow 2, C.I. Basic Yellow 11, C.I. Basic Yellow 12, C.I. Basic Yellow 14, C.I. Basic Yellow 21, C.I. Basic Yellow 32, and C.I. Basic Yellow 36.

Reactive dyes include, for example, C.I. Reactive Black 1, C.I. Reactive Black 3, C.I. Reactive Black 5, C.I. Reactive Black 6, C.I. Reactive Black 8, C.I. Reactive Black 12, and C.I. Reactive Black 14; C.I. Reactive Blue 2, C.I. Reactive Blue 5, C.I. Reactive Blue 7, C.I. Reactive Blue 12, C.I. Reactive Blue 13, C.I. Reactive Blue 14, C.I. Reactive Blue 15, C.I. Reactive Blue 17, C.I. Reactive Blue 18, C.I. Reactive Blue 19, C.I. Reactive Blue 20, C.I. Reactive Blue 21, C.I. Reactive Blue 25, C.I. Reactive Blue 27, C.I. Reactive Blue 28, C.I. Reactive Blue 37, C.I. Reactive Blue 38, C.I. Reactive Blue 40, C.I. Reactive Blue 41, and C.I. Reactive Blue 71; C.I. Reactive Brown 1, C.I. Reactive Brown 7, and C.I. Reactive Brown 16; C.I. Reactive Green 5 and C.I. Reactive Green 7; C.I. Reactive Orange 2, C.I. Reactive Orange 5, C.I. Reactive Orange 7, C.I. Reactive Orange 16, C.I. Reactive Orange 20, and C.I. Reactive Orange 24; C.I. Reactive Red 6, C.I. Reactive Red 7, C.I. Reactive Red 11, C.I. Reactive Red 12, C.I. Reactive Red 15, C.I. Reactive Red 17, C.I. Reactive Red 21, C.I. Reactive Red 23, C.I. Reactive Red 24, C.I. Reactive Red 35, C.I. Reactive Red 36, C.I. Reactive Red 42, C.I. Reactive Red 63, and C.I. Reactive Red 66; C.I. Reactive Violet 2, C.I. Reactive Violet 4, C.I. Reactive Violet 5, C.I. Reactive Violet 8, and C.I. Reactive Violet 9; and C.I. Reactive Yellow 1, C.I. Reactive Yellow 2, C.I. Reactive Yellow 3, C.I. Reactive Yellow 13, C.I. Reactive Yellow 14, C.I. Reactive Yellow 15, and C.I. Reactive Yellow 17. Food dyes include, for example, C.I. Food Black 2; C.I. Food Blue 3, C.I. Food Blue 4, and C.I. Food Blue 5; C.I. Food Green 2 and C.I. Food Green 3; C.I. Food Red 2, C.I. Food Red 3, C.I. Food Red 7, C.I. Food Red 9, C.I. Food Red 14, C.I. Food Red 52, C.I. Food Red 87, C.I. Food Red 92, C.I. Food Red 94, C.I. Food Red 102, C.I. Food Red 104, C.I. Food Red 105, and C.I. Food Red 106; C.I. Food Violet 2; and C.I. Food Yellow 3, C.I. Food Yellow 4, and C.I. Food Yellow 5.

Disperse dyes include, for example, C.I. Disperse Blue 1, C.I. Disperse Blue 3, and C.I. Disperse Blue 14; C.I. Disperse Orange 1, C.I. Disperse Orange 3, C.I. Disperse Orange 13, and C.I. Disperse Orange 25; C.I. Disperse Red 1, C.I. Disperse Red 13, and C.I. Disperse Red 19; and C.I. Disperse Yellow 3, C.I. Disperse Yellow 5, C.I. Disperse Yellow 7, and C.I. Disperse Yellow 9.

Azo dyes may be mentioned as further preferred dyes, and examples thereof include C.I. Acid Black 1, C.I. Acid Black 21, C.I. Acid Black 24, C.I. Acid Black 26, C.I. Acid Black 41, C.I. Acid Black 48, C.I. Acid Black 52, C.I. Acid Black 60, C.I. Acid Black 63, C.I. Acid Black 84, C.I. Acid Black 94, and C.I. Acid Black 123; C.I. Acid Blue 1, C.I. Acid Blue 7, C.I. Acid Blue 9, C.I. Acid Blue 15, C.I. Acid Blue 25, C.I. Acid Blue 27, C.I. Acid Blue 43, C.I. Acid Blue 45, C.I. Acid Blue 47, C.I. Acid Blue 59, C.I. Acid Blue 62, C.I. Acid Blue 69, C.I. Acid Blue 77, C.I. Acid Blue 78, C.I. Acid Blue 83, C.I. Acid Blue 90, C.I. Acid Blue 92, C.I. Acid Blue 102, C.I. Acid Blue 104, C.I. Acid Blue 113, C.I. Acid Blue 120, C.I. Acid Blue 158, C.I. Acid Blue 161, and C.I. Acid Blue 193; C.I. Acid Brown 6, C.I. Acid Brown 8, C.I. Acid Brown 14, C.I. Acid Brown 17, C.I. Acid Brown 20, C.I. Acid Brown 102, and C.I. Acid Brown 105; C.I. Acid Green 3, C.I. Acid Green 5, C.I. Acid Green 9, C.I. Acid Green 12, C.I. Acid Green 19, C.I. Acid Green 20, C.I. Acid Green 25, C.I. Acid Green 35, and C.I. Acid Green 95; C.I. Acid Orange 1, C.I. Acid Orange 6, C.I. Acid Orange 7, C.I. Acid Orange 8, C.I. Acid Orange 10, C.I. Acid Orange 14, C.I. Acid Orange 19, C.I. Acid Orange 20, C.I. Acid Orange 24, C.I. Acid Orange 28, C.I. Acid Orange 33, C.I. Acid Orange 51, C.I. Acid Orange 52, C.I. Acid Orange 61, C.I. Acid Orange 63, C.I. Acid Orange 67, C.I. Acid Orange 74, C.I. Acid Orange 92, C.I. Acid Orange 125, C.I. Acid Orange 127, and C.I. Acid Orange 156; C.I. Acid Red 1, C.I. Acid Red 2, C.I. Acid Red 13, C.I. Acid Red 14, C.I. Acid Red 18, C.I. Acid Red 27, C.I. Acid Red 32, C.I. Acid Red 33, C.I. Acid Red 35, C.I. Acid Red 37, C.I. Acid Red 42, C.I. Acid Red 52, C.I. Acid Red 73, C.I. Acid Red 85, C.I. Acid Red 87, C.I. Acid Red 88, C.I. Acid Red 89, C.I. Acid Red 97, C.I. Acid Red 99, C.I. Acid Red 101, C.I. Acid Red 106, C.I. Acid Red 111, C.I. Acid Red 114, C.I. Acid Red 128, C.I. Acid Red 134, C.I. Acid Red 138, C.I. Acid Red 145, C.I. Acid Red 151, C.I. Acid Red 154, C.I. Acid Red 161, C.I. Acid Red 179, C.I. Acid Red 180, C.I. Acid Red 183, C.I. Acid Red 186, C.I. Acid Red 214, C.I. Acid Red 248, C.I. Acid Red 249, C.I. Acid Red 266, C.I. Acid Red 288, C.I. Acid Red 296, C.I. Acid Red 337, and C.I. Acid Red 351; C.I. Acid Violet 1, C.I. Acid Violet 7, C.I. Acid Violet 9, C.I. Acid Violet 17, C.I. Acid Violet 56, and C.I. Acid Violet 58; C.I. Acid Yellow 7, C.I. Acid Yellow 9, C.I. Acid Yellow 11, C.I. Acid Yellow 17, C.I. Acid Yellow 19, C.I. Acid Yellow 23, C.I. Acid Yellow 25, C.I. Acid Yellow 29, C.I. Acid Yellow 36, C.I. Acid Yellow 38, C.I. Acid Yellow 40, C.I. Acid Yellow 42, C.I. Acid Yellow 44, C.I. Acid Yellow 49, C.I. Acid Yellow 56, C.I. Acid Yellow 59, C.I. Acid Yellow 62, C.I. Acid Yellow 65, C.I. Acid Yellow 72, C.I. Acid Yellow 76, C.I. Acid Yellow 99, C.I. Acid Yellow 118, C.I. Acid Yellow 121, C.I. Acid Yellow 129, C.I. Acid Yellow 135, C.I. Acid Yellow 161, C.I. Acid Yellow 162, C.I. Acid Yellow 171, C.I. Acid Yellow 183, C.I. Acid Yellow 199, and C.I. Acid Yellow 201; C.I. Direct Black 4, C.I. Direct Black 17, C.I. Direct Black 19, C.I. Direct Black 22, C.I. Direct Black 32, C.I. Direct Black 38, C.I. Direct Black 80, C.I. Direct Black 91, C.I. Direct Black 122, and C.I. Direct Black 154; C.I. Direct Blue 1, C.I. Direct Blue 2, C.I. Direct Blue 6, C.I. Direct Blue 10, C.I. Direct Blue 14, C.I. Direct Blue 15, C.I. Direct Blue 22, C.I. Direct Blue 25, C.I. Direct Blue 71, C.I. Direct Blue 76, C.I. Direct Blue 78, C.I. Direct Blue 80, C.I. Direct Blue 95, C.I. Direct Blue 98, C.I. Direct Blue 159, and C.I. Direct Blue 218; C.I. Direct Brown 2, C.I. Direct Brown 27, C.I. Direct Brown 31, C.I. Direct Brown 52, C.I. Direct Brown 95, C.I. Direct Brown 100, and C.I. Direct Brown 222; C.I. Direct Green 1, C.I. Direct Green 6, C.I. Direct Green 26, C.I. Direct Green 28, C.I. Direct Green 33, and C.I. Direct Green 59; C.I. Direct Orange 6, C.I. Direct Orange 26, C.I. Direct Orange 29, C.I. Direct Orange 32, C.I. Direct Orange 39, C.I. Direct Orange 40, C.I. Direct Orange 46, and C.I. Direct Orange 102; C.I. Direct Red 2, C.I. Direct Red 4, C.I. Direct Red 23, C.I. Direct Red 24, C.I. Direct Red 26, C.I. Direct Red 31, C.I. Direct Red 37, C.I. Direct Red 39, C.I. Direct Red 54, C.I. Direct Red 62, C.I. Direct Red 75, C.I. Direct Red 76, C.I. Direct Red 79, C.I. Direct Red 80, C.I. Direct Red 81, C.I. Direct Red 83, C.I. Direct Red 99, C.I. Direct Red 111, C.I. Direct Red 113, C.I. Direct Red 220, and C.I. Direct Red 234; C.I. Direct Violet 7, C.I. Direct Violet 9, C.I. Direct Violet 35, C.I. Direct Violet 47, C.I. Direct Violet 48, C.I. Direct Violet 51, and C.I. Direct Violet 66; and C.I. Direct Yellow 4, C.I. Direct Yellow 8, C.I. Direct Yellow 11, C.I. Direct Yellow 12, C.I. Direct Yellow 22, C.I. Direct Yellow 26, C.I. Direct Yellow 27, C.I. Direct Yellow 29, C.I. Direct Yellow 33, C.I. Direct Yellow 44, C.I. Direct Yellow 50, and C.I. Direct Yellow 106.

These compounds may be used either solely or in a combination of two or more at a desired ratio. When a sulfonic acid, carboxylic acid or other acidic group is contained in the dye structure, an acid form, a salt form thereof or a composite thereof is possible. The types of salts may be the same or different. Likewise, when a base such as amine is contained in the dye structure, a base form, a salt form thereof, or a composite thereof is possible. The types of salts may be the same or different.

Examples of pigments include organic pigments (for example, azo lakes, insoluble azo pigments, condensed azo pigments, chelate azo pigments, phthalocyanine pigments, perylene pigments, perinone pigments, quinacridone pigments, thioindigo pigments, isoindolinone pigments, quinophthalone pigments, dioxazine pigments, anthraquinone pigments, nitro pigments, nitroso pigments, and aniline black) and inorganic pigments (for example, zinc flower, white lead, carbon blacks, iron oxide red, vermillion, cadmium red, chrome yellow, ultramarine blue, cobalt blue, cobalt purple, and zinc chromate). These compounds may be used either solely or in a combination of two or more at a desired ratio.

The ink composition according to the present invention may be produced by dispersing and mixing the above ingredients by a suitable method. For example, a contemplated ink composition may be produced by preparing a solution containing individual ink ingredients, stirring the solution thoroughly, and filtering the stirred solution to remove coarse particles and foreign matter causative of clogging.

### EXAMPLES

The following Examples further illustrate the present invention. However, it should be noted that the present invention is not limited to these Examples.

### Example 1

(1) Preparation of White Pigment for Water-based Ink

n-Hexane (100 ml), 20 g of titanium tetraisopropoxide, and a stirrer were added to a 300-ml vessel at room temperature, and the vessel containing the contents was placed in a methanol bath of about −80° C. and was cooled for about 2 min.

Subsequently, an aqueous emulsion having 20.3% (a concentration on a solid basis) of core particles having a diameter of 0.3 μm (styrene-acryl copolymer, SX866B: manufactured by JSR Corporation) was added to a 1% aqueous NaOH solution, and the mixture was stirred at room temperature for 40 min. This liquid was added dropwise to the above n-hexane solution through a pippette. The dropwise addition was carried out while stirring the n-hexane solution with a stirrer. When the dropwise addition of the aqueous emulsion was continued, white solid matter was precipitated and, consequently, the stirrer became unstirrable.

When the dropwise addition of 70 ml of the aqueous emulsion was completed, the 300-mi vessel was taken out of the methanol bath and was shaken by hand for about 3 min. As a result, the stirrer became stirrable. In this state, the contents of the vessel were vigorously stirred at room temperature for one hr.

After stirring, the contents were centrifuged at 2000 rpm for 30 min. Upon centrifugation, transparent n-hexane was separated on the upper part of the reaction solution, and titanium oxide particles as a by-product were precipitated at the bottom of the vessel. n-Hexane was separated and recovered by a syringe, and titanium oxide as the by-product was removed by dacantation. The emulsion thus obtained was adjusted to pH 9.1 by the addition of a 1% aqueous NaOH solution to prepare an aqueous emulsion 1 containing titanium oxide-covered core particles.

(2) Evaluation of White Pigment for Water-based Ink

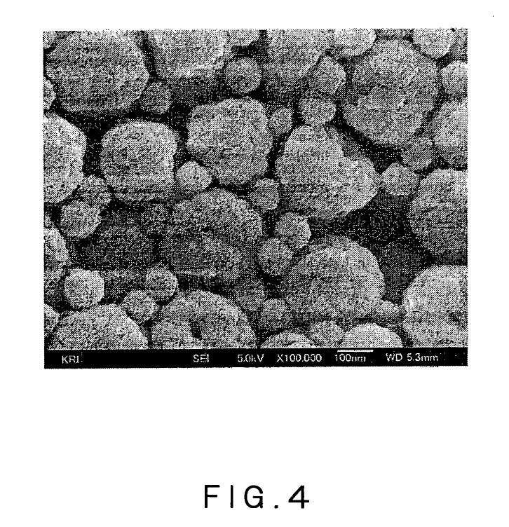

A small amount of the aqueous emulsion 1 thus obtained was bar coated on a slide glass. The thickness of the wetted film was 100 μm. The coating was dried at room temperature for a few min to form a white coating film. The infrared spectroscopic absorption spectrum of this coating film was measured with an infrared spectrophotometer (FT/IR-6300, manufactured by Japan Spectroscopic Co., Ltd.). Further, the surface of the coating film was observed under a scanning electron microscope (S-4700, manufactured by Hitachi, Ltd.). The infrared spectroscopic spectrum and electron photomicrograph thus obtained are shown in FIGS. 3 and 4, respectively. As is apparent from the results shown in FIGS. 3 and 4, the formation of a layer of titanium oxide on the surface of core particles could be confirmed. The particle diameter of the white pigment thus obtained was measured from the electron photomicrograph and was found to be 0.6 μm.

Further, the specific gravity of titanium oxide covering the surface of the resin particles was measured with Accupyc 1300-01 (manufactured by Shimadzu Seisakusho Ltd.) and was found to be 4.3, and the specific gravity of the styrene-acryl copolymer resin was 0.78.

Further, the Raman spectrum of this coating film was measured with a microscopic laser Raman spectrophotometer (NRS-3300, manufactured by Japan Spectroscopic Co., Ltd.). As a result, the titanium oxide was in a noncrystalline state.

### Example 2

An aqueous emulsion 2 containing titanium oxide-covered core particles was prepared in the same manner as in Example 1, except that 100 ml of an aqueous emulsion was placed in a 300-ml flask equipped with a cooling tube and was refluxed with vigorous stirring for 24 hr.

The measurement of an infrared spectroscopic spectrum and observation under an electron microscope were carried out for the aqueous emulsion 2 thus obtained in the same manner as in Example 1. As a result, it could be confirmed that a layer of titanium oxide was formed on the surface of core particles. Further, in the same manner as in Example 1, the particle diameter of the white pigment thus obtained was measured from the electron photomicrograph and was found to be 0.45 μm. Further, a Raman spectrum was measured in the same manner as in Example 1. As a result, it was found that peaks characteristic of anatase crystal structure were observed around 145 cm⁻¹, 396 cm⁻¹, 517 cm⁻¹, and 637 cm⁻¹.

Further, the specific gravity of titanium oxide covering the surface of the resin particles was measured as described above and was found to be 4.1 g/cm³. The specific gravity of the styrene-acryl copolymer resin was the same as that in Example 1.

### Example 3

An aqueous emulsion 3 containing titanium oxide-covered core particles was prepared in the same manner as in Example 1, except that 100 ml of an aqueous emulsion together with a stirrer was placed in a 300-ml pressure-proof hermetic vessel and was treated at 120° C. for 24 hr.

The measurement of an infrared spectroscopic spectrum and observation under an electron microscope were carried out for the aqueous emulsion 3 thus obtained in the same manner as in Example 1. As a result, it could be confirmed that a layer of titanium oxide was formed on the surface of core particles. Further, in the same manner as in Example 1, the particle diameter of the white pigment thus obtained was measured from the electron photomicrograph and was found to be 0.42 μm. Further, a Raman spectrum was measured in the same manner as in Example 1. As a result, it was found that peaks characteristic of anatase crystal structure were observed around 145 cm⁻¹, 396 cm⁻¹, 517 cm⁻¹, and 637 cm⁻¹.

Further, the specific gravity of titanium oxide covering the surface of the resin particles was measured as described above and was found to be 4.1 g/cm³. The specific gravity of the styrene-acryl copolymer resin was the same as that in Example 1.

The aqueous emulsions prepared in Examples 1 to 3 were concentrated to a solid content of 20% by weight to prepare aqueous emulsions 1B to 3B. Ink compositions 1 to 6 were prepared according to the following formulations.

For the ink composition 6, the aqueous emulsion was the same as the aqueous emulsion 1B, except that the aqueous emulsion was used in a state before covering with titanium.

Ink composition 1

| | |
|---|---|
| Aqueous emulsion 1B | 50 wt % |
| Glycerin | 10 wt % |
| Olfine E1010 | 0.5 wt % |
| Triethanolamine | 0.5 wt % |
| Pure water | Balance |

Ink Compositions 2 and 3

Ink compositions 2 and 3 were prepared in the same manner as in the ink composition 1, except that aqueous emulsions 2B and 3B were used instead of aqueous emulsion 1B.

### Example 4

TITANIX JR-701 (manufactured by Tayca Corporation) was used as titanium oxide particles. The titanium oxide particles had a diameter of 0.27 μm.

Further, particles of a styrene-acryl copolymer resin (SX866B: manufactured by JSR Corporation) having a diameter of 0.3 μm were used as resin particles.

Titanium oxide, a dispersant (styrene-acrylic acid copolymer), and water were mixed together, and the mixture, together with glass beads (diameter: 1.7 mm, amount: 1.5 times larger than the mixture), was dispersed for 2 hr in a sand mill (manufactured by Yasukawa Seisakusho), and the glass beads were removed to prepare a titanium oxide dispersion liquid. Separately, an aqueous emulsion (the same as the aqueous emulsion 1B except that the aqueous emulsion titanium covering had not been carried out, that is, the aqueous emulsion was used in a state before carrying out the titanium covering), glycerin, Olfine E1010, triethanolamine, and pure water were mixed together to prepare an ink solvent. The titanium oxide dispersion liquid was added by portions to the ink solvent with stirring, and the mixture was stirred at room temperature for 30 min. The mixture was then filtered through an 8-μm membrane filter to prepare a contemplated ink composition 4. The ink had the following composition.

Ink composition 4

| | |
|---|---|
| Titanium oxide particles | 10 wt % |
| Styrene-acrylic acid copolymer | 2 wt % |
| Aqueous emulsion | 50 wt % |
| Glycerin | 10 wt % |
| Olfine E1010 | 0.5 wt % |
| Triethanolamine | 0.9 wt % |
| Pure water | Balance |

### Comparative Example 1

An ink composition 5 was prepared in the same manner as in Example 4, except that no aqueous emulsion was added. The ink had the following composition.

Ink composition 5

| | |
|---|---|
| Titanium oxide particles | 10 wt % |
| Styrene-acrylic acid copolymer | 2 wt % |
| Glycerin | 10 wt % |
| Olfine E1010 | 0.5 wt % |
| Triethanolamine | 0.9 wt % |
| Pure water | Balance |

Next, an ink composition 6 for use as an evaluation standard in the following evaluation of ink was prepared in the same manner as described above. The ink had the following composition. In the ink composition 6, core particles in a state before titanium oxide covering treatment were used instead of the white pigment.

Ink composition 6

| | |
|---|---|
| Aqueous emulsion | 50 wt % |
| Glycerin | 10 wt % |
| Olfine E1010 | 0.5 wt % |
| Triethanolamine | 0.9 wt % |
| Pure water | Balance |

Evaluation of Covering Power of White Ink

The ink compositions 1 to 6 were printed on an EPSON specialty OHP sheet (manufactured by Seiko Epson Corporation) by PX-V500 (manufactured by Seiko Epson Corporation).

Printed matters produced using the ink compositions were visually evaluated according to the following evaluation criteria.

A: The covering power was superior to that of ink composition 6.

B: The covering power was comparable to that of ink composition 6.

C: The covering power was inferior to that of ink composition 6.

The results were as shown in Table 1 below.

Evaluation of Printing Stability

Similarly, these ink compositions 1 to 5 were printed on an EPSON specialty OHP sheet (manufactured by Seiko Epson Corporation) by PX-V500 (manufactured by Seiko Epson Corporation) for visual inspection of an ink dropout/droplet trajectory directionality problem.

A: The printing stability was comparable to that of ink composition 6.

B: Printing could be performed, although the ink dropout/droplet trajectory directionality problem was slightly more significant than that of ink composition 6.

C: As compared with ink composition 6, the ink dropout/droplet trajectory directionality problem was more significant, and the printing stability was inferior.

Evaluation of Sedimentation

Evaluation of particle sedimentation in white pigment-containing aqueous emulsions for ink was carried out. Each ink composition was placed in a vessel and was allowed to stand for 10 days, and the state of the bottom of the vessel was visually inspected. The results were evaluated according to the following criteria.

A: The particle sedimentation was comparable to that of ink composition 6, and neither sediment nor precipitate was observed.

B: The particle sedimentation was slightly inferior to that of ink composition 6, and sediment and precipitate were observed.

C: The particle sedimentation was inferior to that of ink composition 6, and sediment and precipitate were significantly observed. The results were as shown in Table 1 below.

TABLE 1

| | Evaluation | | |
|---|---|---|---|
| Ink | | Printing | |
| composition | Covering power | stability | Sedimentation |
| Ink composition 1 | A | B | B |
| Ink composition 2 | A | A | A |
| Ink composition 3 | A | A | A |
| Ink composition 4 | A | A | B |
| Ink composition 5 | A | B | C |
| (Comparative) | | | |

1. A white pigment for a water-based ink, comprising particles each comprising: a core particle formed of a material having a lower specific gravity than titanium oxide; and a titanium oxide layer covering the surface of the core particle, the pigment having a particle diameter of 0.05 to 5 μm.

2. The white pigment for a water-based ink according to claim 1, wherein the titanium oxide is in a noncrystalline form.

3. The white pigment for a water-based ink according to claim 1, wherein the titanium oxide is in an anatase crystalline form.

4. The white pigment for a water-based ink according to claim 1, wherein the core particle has a hollow structure.

5. The white pigment for a water-based ink according to claim 1, wherein the core particle has a particle diameter of 0.01 to 3 μm.

6. A white pigment for a water-based ink, comprising titanium oxide particles and resin particles having a lower specific gravity than titanium oxide, wherein
the mixing weight ratio between the titanium oxide particles and the resin particles is 5:1 to 1:30.

7. The white pigment for a water-based ink according to claim 6, wherein the resin particles have a hollow structure.

8. The white pigment for a water-based ink according to claim 6, wherein the titanium oxide particles have a diameter of 0.05 to 5 μm.

9. The white pigment for a water-based ink according to claim 6, wherein the resin particles have a particle diameter of 0.01 to 3 μm.

10. The white pigment for a water-based ink according to claim 6, wherein the titanium oxide is in a noncrystalline form.

11. The white pigment for a water-based ink according to claim 6, wherein the titanium oxide is in an anatase crystalline form.

12. A process for producing a white pigment for a water-based ink, comprising particles each comprising: a core particle formed of a material having a lower specific gravity than titanium oxide; and a titanium oxide layer covering the surface of the core particle, the pigment having a particle diameter of 0.05 to 5 μm, the process comprising:
providing an aqueous emulsion containing the core particles;
adding the aqueous emulsion to an organic solvent containing a titanium alkoxide dissolved therein; and
precipitating titanium oxide on the surface of the core particles by hydrolysis of the titanium alkoxide.

13. The process according to claim 12, wherein the aqueous emulsion is added at a temperature of −20° C. or below.

14. The process according to claim 12, wherein the organic solvent is an aprotic solvent.

15. The process according to claim 14, wherein the aprotic solvent is at least one solvent selected from the group consisting of aromatic hydrocarbon solvents, aliphatic hydrocarbon solvents, ether solvents, ketone solvents, and ester solvents.

16. The process according to claim 12, which further comprises the step of, after the addition of the aqueous emulsion to the organic solvent, heat treating the mixture in a hermetically sealed vessel.

17. The process according to claim 16, wherein the heat treatment is carried out at a temperature of 100° C. or above.

18. The process according to claim 12, wherein the core particle has a hollow structure.

19. An ink composition for ink jet recording, comprising at least a colorant and water, the colorant comprising a white pigment for a water-based ink according to claim 1.
